(19) United States
(12) Patent Application Publication
(10) Pub. No.: US 2022/0079380 A1
(43) Pub. Date: Mar. 17, 2022

(54) Corn On The Cob Roasting Assembly

(71) Applicant: Savita Dubey, Iselin, NJ (US)

(72) Inventor: Savita Dubey, Iselin, NJ (US)

(21) Appl. No.: 17/022,966

(22) Filed: Sep. 16, 2020

(51) Int. Cl. A47J 37/06

(52) U.S. Cl. CPC A47J 37/0629

(57) ABSTRACT

A corn on the cob roasting assembly for roasting corn on the cob includes a toaster oven that has a plurality of wells extending into a top side of the toaster oven for insertably receiving a corn on the cob. A plurality of heating cages is positioned within a respective one of the wells to surround the corn on the cob that is positioned in each of the wells. Each of the heating cages produces heat to cook the corn on the cob. A control unit is coupled to the toaster oven and the control unit is in communication with each of the heating cages for controlling operational parameters of the heating cages. The control unit adjusts the operational temperature of the heating cages between a low intensity, a medium intensity or a high intensity.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to roasting devices and more particularly pertains to a new roasting device for roasting corn on the cob.

### (2) Description of Related Art Including Information Disclosed Under 37 CFR 1.97 and 1.98

The prior art relates to roasting devices including a variety of toaster ovens which has cylindrical cooking elements for cooking more than one ear of corn on the cob. The prior art discloses a toaster oven that has a single cylindrical cooking element for cooking a single ear of corn on the cob. The prior art discloses a toaster oven that has a bun sleeve and a hot dog sleeve for roasting a hot dog and a hot dog bun in a vertical orientation. The prior art discloses a toaster oven that has a plurality of cylindrical wells and a plurality of rectangular wells for simultaneously roasting ears of corn on the cob and toasting slices of bread.

### BRIEF SUMMARY OF THE INVENTION

An embodiment of the disclosure meets the needs presented above by generally comprising a toaster oven that has a plurality of wells extending into a top side of the toaster oven for insertably receiving a corn on the cob. A plurality of heating cages is positioned within a respective one of the wells to surround the corn on the cob that is positioned in each of the wells. Each of the heating cages produces heat to cook the corn on the cob. A control unit is coupled to the toaster oven and the control unit is in communication with each of the heating cages for controlling operational parameters of the heating cages. The control unit adjusts the operational temperature of the heating cages between a low intensity, a medium intensity or a high intensity.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a corn on the cob roasting assembly according to an embodiment of the disclosure.

FIG. 2 is a right side view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a perspective view a heating cage of an embodiment of the disclosure.

FIG. 6 is a top perspective view of an embodiment of the disclosure.

### DETAILED DESCRIPTION OF THE INVENTION

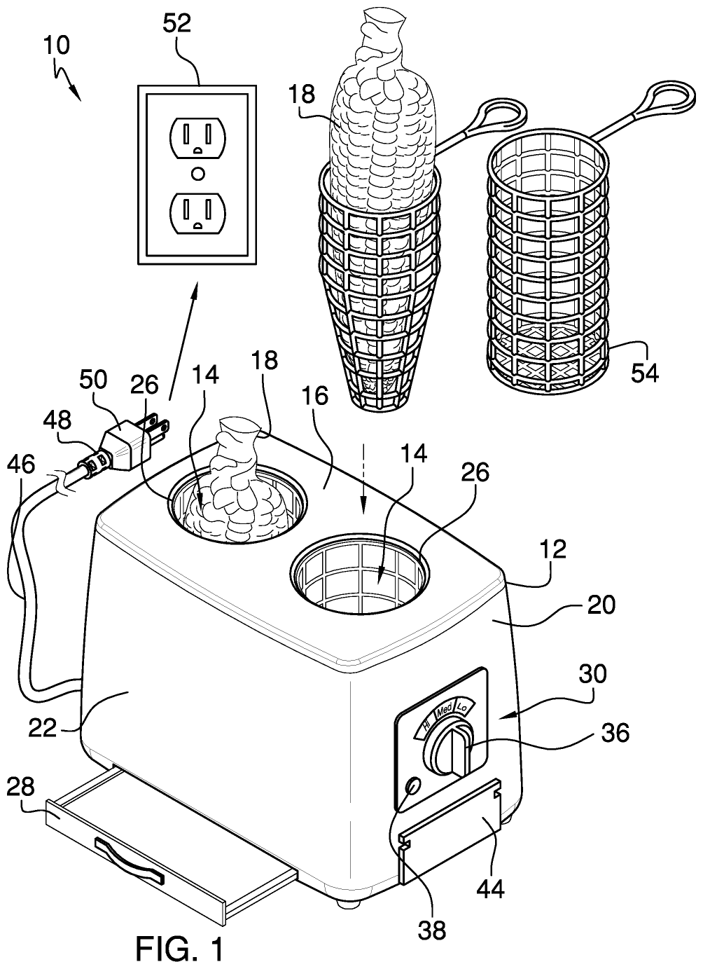

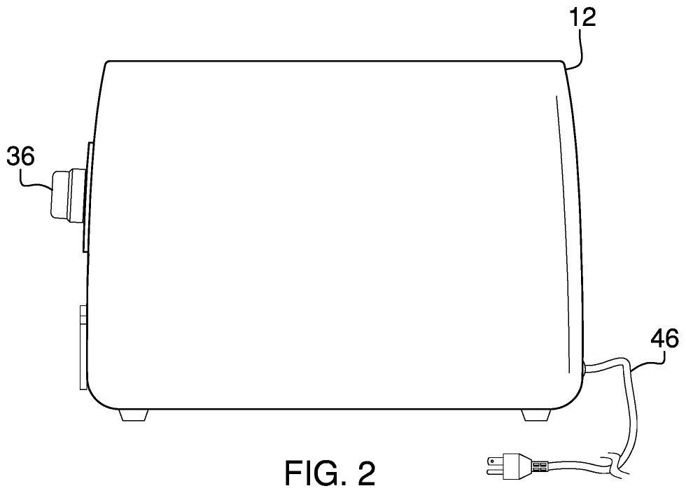

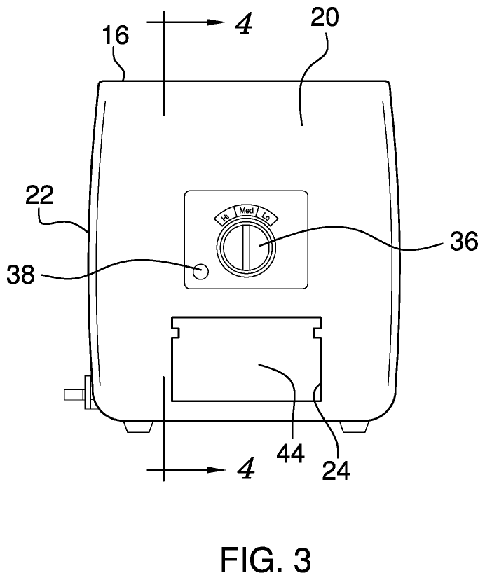

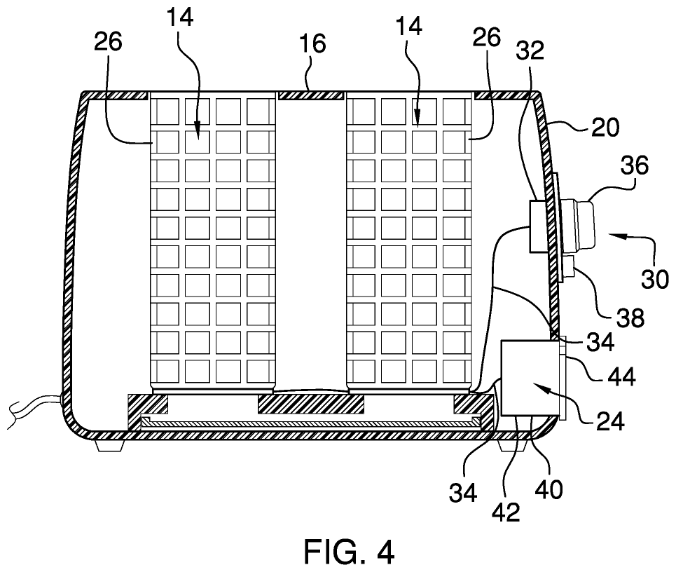

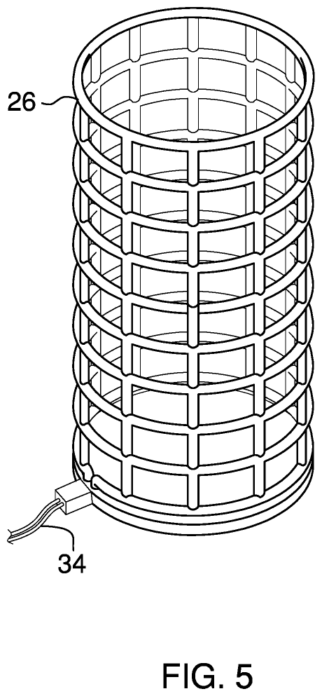

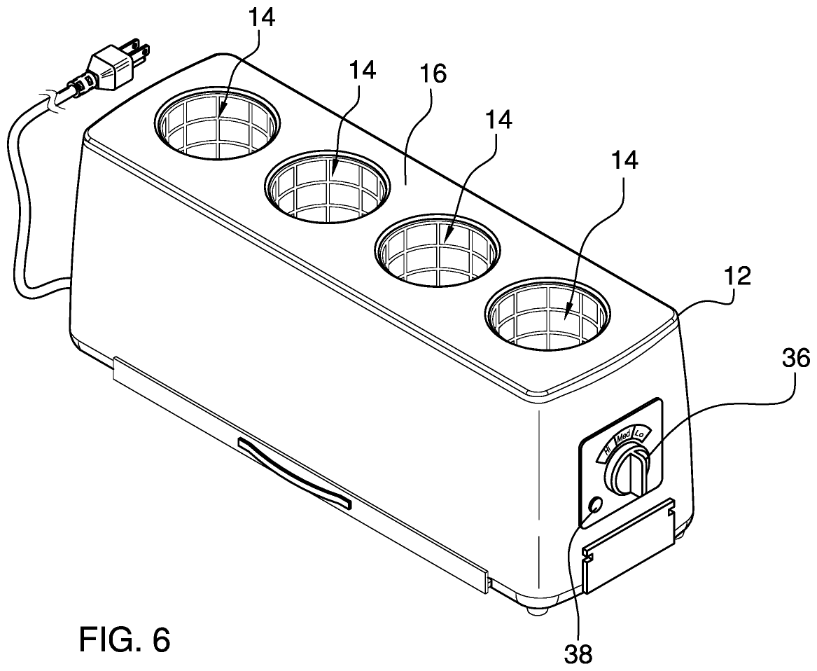

With reference now to the drawings, and in particular to FIGS. 1 through 6 thereof, a new roasting device embodying the principles and concepts of an embodiment of the disclosure and generally designated by the reference numeral 10 will be described.

As best illustrated in FIGS. 1 through 6, the corn on the cob roasting assembly 10 generally comprises a toaster oven 12 that has a plurality of wells 14 extending into a top side 16 of the toaster oven 12 for insertably receiving corn on the cob 18. The toaster oven 12 has a front side 20 and a first lateral side 22, and the front side 20 has a battery opening 24 extending into an interior of the toaster oven 12. A plurality of heating cages 26 is each positioned within a respective one of the wells 14 to surround the corn on the cob 18 that is positioned in each of the wells 14. Each of the heating cages 26 produces heat when the heating cages 26 are turned on. In this way each of the heating cages 26 cooks the corn on the cob 18.

Each of the heating cages 26 is continuously arcuate about a center point of the heating cages 26 such that each of the heating cages 26 has a cylindrical shape. Moreover, each of the heating cages 26 is comprised of an electrically resistive material such that each of the heating cages 26 produces heat when the heating cages 26 are turned on. Each of the heating cages 26 is vertically elongated such that each of the heating cages 26 extends along a full height of the respective well 14. In this way each of the heating cages 26 can cook the full length and the full circumference of the corn on the cobs 18. As is most clearly shown in FIGS. 1, 4 and 6, the number of wells 14 and heating cages 26 may range between two and four.

A tray 28 is provided and the tray 28 is slidably integrated into the toaster oven 12. The tray 28 is positioned beneath each of the wells 14 to capture crumbs and particles from the corn on the cobs 18. Moreover, the tray 28 is removable from the toaster oven 12 for dumping the crumbs and particles. The tray 28 is slidable inwardly and outwardly from the first lateral side 22 of the toaster oven 12.

A control unit 30 is provided and the control unit 30 is coupled to the toaster oven 12. The control unit 30 is in communication with each of the heating cages 26 for controlling operational parameters of the heating cages 26. Additionally, the control unit 30 is adjustable between a low intensity, a medium intensity and a high intensity for adjusting the operational temperature of the heating cages 26 between a corresponding low intensity, medium intensity or high intensity. The control unit 30 comprises a control circuit 32 that is coupled to the toaster oven 12. The control circuit 32 receives a low input, a medium input and a high input.

The control unit 30 includes a plurality of conductors 34 that is each electrically coupled between the control circuit 32 and a respective one of the heating cages 26. Each of the heating cages 26 is actuated to the low intensity when the control circuit 32 receives the low input. Each of the heating cages 26 is actuated to the medium intensity when the control circuit 32 receives the medium input. Additionally, each of the heating cages 26 is actuated to the high intensity when the control circuit 32 receives the high input.

The control unit 30 includes a control knob 36 that is rotatably coupled to the front side 20 of the toaster oven 12 and the control knob 36 is electrically coupled to the control circuit 32. The control circuit 32 receives the low input when the control knob 36 is positioned in a low position. The control circuit 32 receives the medium input when the control knob 36 is positioned in a medium position. Additionally, the control circuit 32 receives the high input when the control knob 36 is positioned in a high position.

The control unit 30 includes a power button 38 that is movably coupled to the front the of the toaster oven 12. The power button 38 is electrically coupled to the control circuit 32 for turning the control circuit 32 on and off. The control unit 30 includes a power supply 40 that is positioned in the toaster oven 12 and the power supply 40 is electrically coupled to the control circuit 32. The power supply 40 comprises a rechargeable battery 42 that is positioned in the battery opening 24 in the front side 20 of the toaster oven 12 and the rechargeable battery 42 is electrically coupled to the control circuit 32. A battery cover 44 is removably coupled to the front side 20 of the toaster oven 12 to cover the battery opening 24.

The control unit 30 includes a power cord 46 that is coupled to and extends away from the toaster oven 12. The power cord 46 has a distal end 48 and a male plug 50 is electrically coupled to the distal end 48 for engaging a power source 52 comprising a female electrical outlet. The power cord 46 is electrically coupled to the rechargeable battery 42 for charging the rechargeable battery 42 and the power cord 46 is in electrical communication with the control circuit 32 for powering the control circuit 32 while the rechargeable battery 42 is charging. As is most clearly shown in FIG. 1, a basket 54 is provided for lowering the corn on the cobs 18 into, and subsequently removing the corn on the cob 18 from, the respective heating cage 26.

In use, a corn on the cob 18 is placed into each of the heating cages 26 in the toaster oven 12 and the control knob 36 is rotated into either of the low position, the medium position or the high position. The power button 38 is depressed to turn on the heating cages 26 and cook the corn on the cobs 18. In this way the corn on the cobs 18 can be cooked in a timely manner without the use of a gas grill, charcoal grill or other similar means of roasting corn on the cobs 18. The corn on the cobs 18 are removed from the heating cages 26 after sufficient cooking time has passed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A corn on the cob roasting assembly for roasting a plurality of cobs of corn in a timely manner, said assembly comprising:
a toaster oven having a plurality of wells extending into a top side of said toaster oven wherein each of said wells is configured to insertably receive a corn on the cob;
a plurality of heating cages, each of said heating cages being positioned within a respective one of said wells wherein each of said heating cages is configured to surround the corn on the cob that is positioned in each of said wells, each of said heating cages producing heat when said heating cages are turned on wherein each of said heating cages is configured to cook the corn on the cob; and
a control unit being coupled to said toaster oven, said control unit being in communication with each of said heating cages for controlling operational parameters of said heating cages, said control unit being adjustable between a low intensity, a medium intensity and a high intensity for adjusting the operational temperature of said heating cages between a corresponding low intensity, medium intensity or high intensity.

2. The assembly according to claim 1, wherein each of said heating cages is continuously arcuate about a center point of said heating cages such that each of said heating cages has a cylindrical shape, each of said heating cages being comprised of an electrically resistive material such that each of said heating cages produces heat when said heating cages are turned on, each of said heating cages being vertically elongated such that each of said heating cages extends along a full height of said respective well wherein each of said heating cages is configured to cook the full length and the full circumference of the corn on the cobs.

3. The assembly according to claim 1, wherein:
said toaster oven has a front side and a first lateral side, said front side having a battery opening extending into an interior of said toaster oven; and
said assembly includes a tray being slidably integrated into said toaster oven, said tray being positioned beneath each of said wells wherein said tray is configured to capture crumbs and particles from the corn on the cob, said tray being removable from said toaster oven for dumping the crumbs and particles, said tray being slidable inwardly and outwardly from said first lateral side of said toaster oven.

4. The assembly according to claim 1, wherein said control unit comprises a control circuit being coupled to said toaster oven, said control circuit receiving a low input, a medium input and a high input.

5. The assembly according to claim 4, wherein said control unit comprises a plurality of conductors, each of said conductors being electrically coupled between said control circuit and a respective one of said heating cages, each of said heating cages being actuated to said low intensity when said control circuit receives said low input, each of said heating cages being actuated to said medium intensity when said control circuit receives said medium input, each of said heating cages being actuated to said high intensity when said control circuit receives said high input.

6. The assembly according to claim 4, wherein said control unit includes a control knob being rotatably coupled to a front side of said toaster oven, said control knob being electrically coupled to said control circuit, said control circuit receiving said low input when said control knob is positioned in a low position, said control circuit receiving said medium input when said control knob is positioned in a medium position, said control circuit receiving said high input when said control knob is positioned in a high position.

7. The assembly according to claim 4, wherein said control unit includes a power button being movably coupled to said front said of said toaster oven, said power button being electrically coupled to said control circuit for turning said control circuit on and off.

8. The assembly according to claim 4, wherein:
said toaster oven has a front side, said front side having a battery opening extending into an interior of said toaster oven; and
said control unit includes a power supply being positioned in said toaster oven, said power supply being electrically coupled to said control circuit, said power supply comprising:
a rechargeable battery being positioned in said battery opening in said front side of said toaster oven, said rechargeable battery being electrically coupled to said control circuit, said
a power cord being coupled to and extending away from said toaster oven, said power cord having a distal end, said distal end having a male plug being electrically coupled thereto for engaging a power source comprising a female electrical outlet, said power cord being electrically coupled to said rechargeable battery for charging said rechargeable battery, said power cord being in electrical communication with said control circuit for powering said control circuit while said rechargeable battery is charging.

9. A corn on the cob roasting assembly for roasting a plurality of cobs of corn in a timely manner, said assembly comprising:
a toaster oven having a plurality of wells extending into a top side of said toaster oven wherein each of said wells is configured to insertably receive a corn on the cob, said toaster oven having a front side and a first lateral side, said front side having a battery opening extending into an interior of said toaster oven;
a plurality of heating cages, each of said heating cages being positioned within a respective one of said wells wherein each of said heating cages is configured to surround the corn on the cob that is positioned in each of said wells, each of said heating cages producing heat when said heating cages are turned on wherein each of said heating cages is configured to cook the corn on the cob, each of said heating cages being continuously arcuate about a center point of said heating cages such that each of said heating cages has a cylindrical shape, each of said heating cages being comprised of an electrically resistive material such that each of said heating cages produces heat when said heating cages are turned on, each of said heating cages being vertically elongated such that each of said heating cages extends along a full height of said respective well wherein each of said heating cages is configured to cook the full length and the full circumference of the corn on the cobs;
a tray being slidably integrated into said toaster oven, said tray being positioned beneath each of said wells wherein said tray is configured to capture crumbs and particles from the corn on the cob, said tray being removable from said toaster oven for dumping the crumbs and particles, said tray being slidable inwardly and outwardly from said first lateral side of said toaster oven;
a control unit being coupled to said toaster oven, said control unit being in communication with each of said heating cages for controlling operational parameters of said heating cages, said control unit being adjustable between a low intensity, a medium intensity and a high intensity for adjusting the operational temperature of said heating cages between a corresponding low intensity, medium intensity or high intensity, said control unit comprising:
a control circuit being coupled to said toaster oven, said control circuit receiving a low input, a medium input and a high input;
a plurality of conductors, each of said conductors being electrically coupled between said control circuit and a respective one of said heating cages, each of said heating cages being actuated to said low intensity when said control circuit receives said low input, each of said heating cages being actuated to said medium intensity when said control circuit receives said medium input, each of said heating cages being actuated to said high intensity when said control circuit receives said high input;
a control knob being rotatably coupled to said front side of said toaster oven, said control knob being electrically coupled to said control circuit, said control circuit receiving said low input when said control knob is positioned in a low position, said control circuit receiving said medium input when said control knob is positioned in a medium position, said control circuit receiving said high input when said control knob is positioned in a high position;
a power button being movably coupled to said front said of said toaster oven, said power button being electrically coupled to said control circuit for turning said control circuit on and off; and
a power supply being positioned in said toaster oven, said power supply being electrically coupled to said control circuit, said power supply comprising:
a rechargeable battery being positioned in said battery opening in said front side of said toaster oven, said rechargeable battery being electrically coupled to said control circuit, said
a power cord being coupled to and extending away from said toaster oven, said power cord having a distal end, said distal end having a male plug being electrically coupled thereto for engaging a power source comprising a female electrical outlet, said power cord being electrically coupled to said rechargeable battery for charging said rechargeable battery, said power cord being in electrical communication with said control circuit for powering said control circuit while said rechargeable battery is charging.
